(19) United States
(12) Patent Application Publication
(10) Pub. No.: US 2006/0077678 A1
(43) Pub. Date: Apr. 13, 2006

(54) Automatic light and vibration sensing bicycle lamp

(76) Inventor: Wen-Sung Chen, Taichung County (TW)

Correspondence Address: BIRCH STEWART KOLASCH & BIRCH, PO BOX 747, FALLS CHURCH, VA, 22040-0747, US

(21) Appl. No.: 10/960,977

(22) Filed: Oct. 12, 2004

(51) Int. Cl. B62J 6/00

(52) U.S. Cl. 362/475; 362/473; 362/276

(57) ABSTRACT

The present invention discloses a bicycle lamp that can be lit automatically by the control of a light sensor unit and a vibration switch unit of a control unit when a bicycle travels in dark places or at nighttime. On the other hand, if the light sensor unit detects a sufficient level of brightness of the environment or the vibration switch unit has not detected the bicycle being in a traveling status, the control unit will put off the bicycle lamp.

### FIELD OF THE INVENTION

The present invention relates to an automatic light and vibration sensing bicycle lamp, more particularly to a bicycle lamp that will be lit automatically to assure a safe ride for bicycle riders at nighttime or in dark places.

### BACKGROUND OF THE INVENTION

In addition to reflective stickers, traditional bicycles also install lamps to provide the required lighting and improve the safety for bicycle rider to ride a bicycle at nighttime. However, the electric generating device used by traditional bicycles still has the following shortcomings.

The electric generator for traditional bicycle lamps generally has a linear threaded rotary wheel in contact with the lateral side of a bicycle tire. When the tire is turning, the lateral side drives the aforementioned rotary wheel to rotate by friction. Therefore, it requires a large, lateral pushing force when the rotary wheel is in contact with the lateral side of the tire. Such pushing force acting on the lateral side of the tire makes pedaling movement of a rider very laborious and also makes the rider feel uncomfortable since the wheel of the bicycle tends to skid to one side. Further, when the rider is riding on a rough road surface, the abovementioned rotary wheel may be separated intermittently from the bicycle tire due to the vibration, which will cause an unstable blinking light to the bicycle lamp and affect the rider's safety.

### SUMMARY OF THE INVENTION

Therefore, the primary objective of the present invention is to provide a bicycle lamp that will be lit automatically to improve the safety for bicycle riders at nighttime or in dark places. The present invention discloses an automatic light and vibration sensing bicycle lamp, such that when a bicycle travels at nighttime or in dark places, a light sensor detects the low level of brightness at nighttime or in dark places to produce a short circuit status; a vibration switch unit produces a short circuit status when it is affected by external forces; and a delay unit receives a signal from a power supply unit to issue a power signal to the bicycle lamp to light up the bicycle lamp. On the other hand, if the bicycle travels from a dark place to a bright place, the light sensor detects the sufficiently high level of brightness of the environment to produce an electrically connected circuit status. Therefore, the power supply unit is unable to receive the signal inputted from the power supply unit and the delay unit is unable to send out the power signal to the bicycle lamp to automatically put out the light of the bicycle lamp, even if the vibration switch unit detects the vibration force while the bicycle is traveling on a rough road surface.

To make it easier for our examiner to understand the objective of the invention, its structure, innovative features, and performance, we use a preferred embodiment and the attached drawings for the detailed description of the invention.

### BRIEF DESCRIPTION OF THE DRAWINGS

FIG. 1 is a block diagram of the automatic light and vibration sensing bicycle lamp according to the present invention.

FIG. 2 is an illustrative view of the automatic light and vibration sensing bicycle lamp being in use according to the present invention.

FIG. 3 is a block diagram of the control unit according to the present invention.

### DETAILED DESCRIPTION OF THE PREFERRED EMBODIMENTS

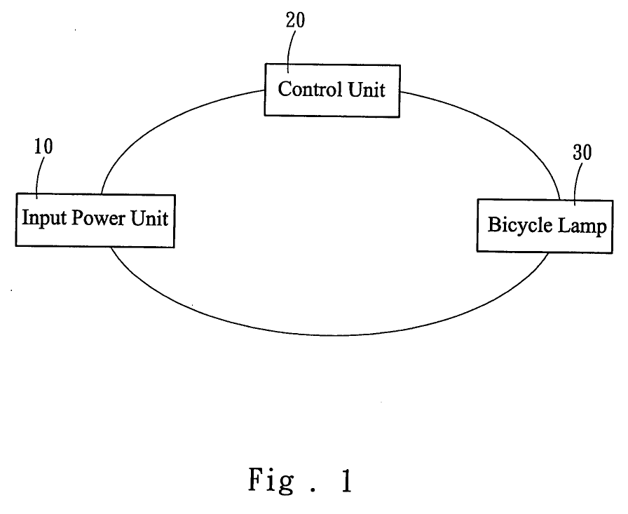

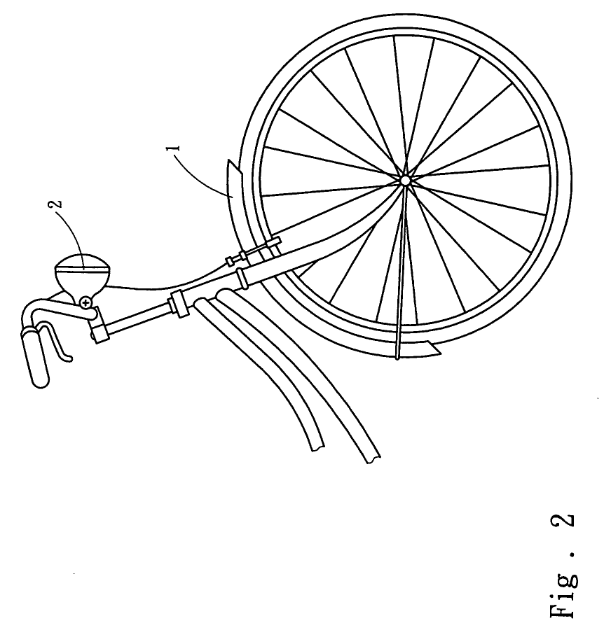

Please refer to FIGS. 1 and 2 for the automatic light and vibration sensing bicycle lamp according to the present invention, which comprises a bicycle body 1 and a bicycle lamp base 2, and the bicycle lamp base 2 comprises an input power unit 10, a control unit 20 and a bicycle lamp 30.

The input power unit 10 (which could be a general battery) is coupled to the control unit 20, and the control unit 20 is coupled separately to the input power unit 10 and the bicycle lamp 30. The input power unit 10 is used to provide the require power supply for the control unit 20.

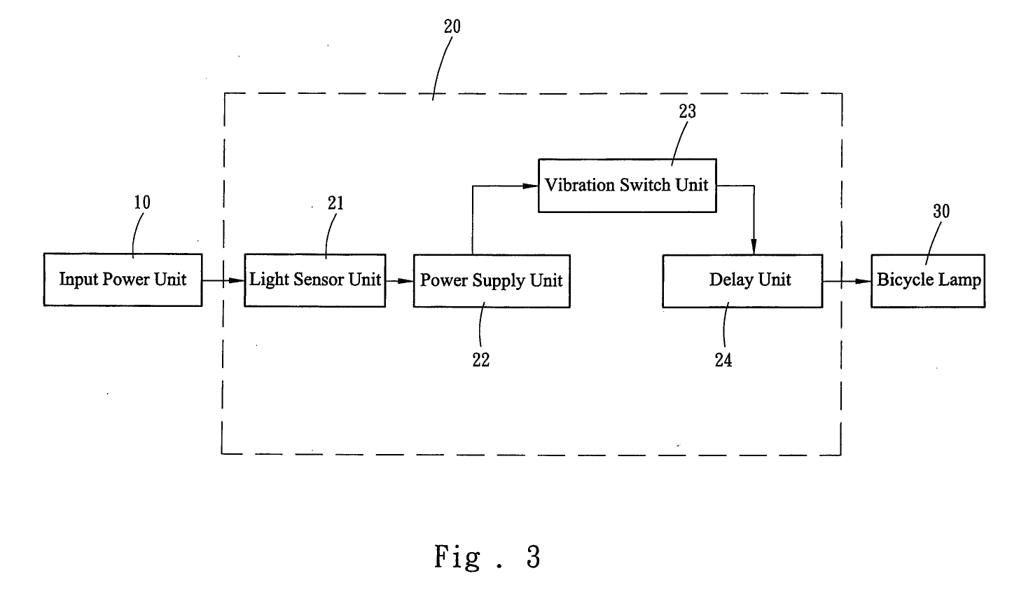

Please refer to FIG. 3 for the control unit 20 according to the present invention. The control unit 20 comprises a light sensor unit 21, a power supply unit 22, a vibration switch unit 23 and a delay unit 24; wherein the light sensor unit 21 (which could be a CdS photoresistor) is coupled to the input power unit 10, and the power supply unit 22 is coupled separately to the light sensor unit 21 and the vibration switch unit 23, and the delay unit 24 is coupled separately to the vibration switch unit 23 and the bicycle lamp 30.

If the light sensor unit 21 detects sufficient light from the environment, an electrically connected status will be formed and thus the power supply unit 22 will not receive the signal sent from the input power supply unit 10. On the other hand, if the light sensor unit 21 detects insufficient light from the environment or at nighttime, a short circuit status will be produced, and thus the power supply unit 22 will receive the signal sent from the input power supply unit 10 and the power supply unit 22 will transmit a signal to the vibration switch unit 24. Then, if the vibration switch unit 23 is affected by the external vibration force, the short circuit and the electric circuit will be generated intermittently. When the vibration switch unit 23 produces a short circuit, then the delay unit 24 will receive the signal from the power supply unit 22 and send a power signal to the bicycle lamp 30.

If the delay unit 24 has not received the short circuit message of the vibration switch 23 before the timing cycle ends, then the vibration switch unit 23 will not be affected by external forces, and thus will produce an electrically connected status. As a result, the delay unit 24 cannot obtain the signal of the power supply unit 22, and the delay unit 24 will immediately disconnect the power supply and no electric power will be outputted to the bicycle lamp 30. In other words, if the light source of the environment is insufficient or the bicycle is traveling at nighttime and the vibration switch unit 23 is affected by external vibration forces, the bicycle lamp 30 will light up automatically. On the other hand, if the light source of the environment is sufficient or the bicycle is traveling during daytime, the bicycle lamp 30 will not light up, even if the vibration switch unit 23 is affected by external vibration forces.

With the foregoing description of the operation of each unit of the control unit 20, we can understand that the automatic light and vibration sensing bicycle lamp of the invention has the advantage of automatically lighting up the bicycle lamp 30 of the bicycle lamp base 2 when the bicycle body 1 is situated at nighttime or in dark places. If a light sensor unit 21 detects an insufficient light source of the environment or at nighttime, a short circuit status will be produced. When the bicycle body 1 is in the traveling status, the vibration switch unit 23 will produce a short circuit status caused by external vibration forces. Therefore, the delay unit 24 will receive a signal from the power supply unit 22 and send a power signal to the bicycle lamp 30 to light up the bicycle lamp 30 automatically.

On the other hand, if the bicycle lamp 30 moves from a dark place to a bright place, the light sensor unit 21 will produce an electrically connected status when it detects a sufficient light source of the environment. Therefore, the power supply unit 22 cannot receive the signal from the power supply unit 10. By then, even if the vibration switch 24 detects a vibration force while the bicycle body 1 is traveling, the delay unit 24 still cannot send out the power signal to the bicycle lamp 30, and thus the bicycle lamp 30 will be put off automatically.

In other words, the bicycle lamp 30 of the present invention will light up automatically only if the bicycle body 1 is situated in a dark place and while it is traveling. On the other hand, when the bicycle body 1 is situated at a bright place, the bicycle lamp 30 will be put off, even if the bicycle body 1 is in the traveling status.

It is noteworthy that after the bicycle lamp 30 lights up automatically and the bicycle body stops traveling for a period of time (say, one to two minutes) indicating that the vibration switch unit 24 of the control unit 20 is not affected by external vibration forces, the bicycle lamp 30 will be in an electrically connected status for a long time and cannot receive the signal from the power supply unit 22 to put off the bicycle lamp 30 automatically.

The automatic light and vibration sensing bicycle lamp according to the present invention can effectively overcome the shortcomings of the electric generating device and its applications for a prior-art bicycle lamp by providing an automatic on/off bicycle lamp 30 as to improve the safety of riding a bicycle at nighttime.

What is claimed is:

1. An automatic light and vibration sensing bicycle lamp, comprising
a bicycle lamp base and said bicycle lamp base comprising an input power supply unit;
a control unit and a bicycle lamp, and said input control unit being coupled separately to said power supply unit and said bicycle lamp and using said input power supply unit to provide the required power supply for said control unit;
characterized in that said control unit comprising a light sensor unit, a power supply unit, a vibration switch unit and a delay unit; wherein said light sensor unit detecting the level of a light source of an environment as a basis for determining to receive a signal of said input power supply unit; said power supply unit receiving said signal of said light sensor unit and sending said signal to said vibration switch unit, and said vibration switch unit determining to send a signal to said delay unit according to the condition of its being affected by an external vibration force and said delay unit determining to send out a signal to said bicycle lamp according to the condition of said signal being received by said vibration switch unit.

2. The automatic light and vibration sensing bicycle lamp of claim 1, wherein said input power supply unit is a battery.

3. The automatic light and vibration sensing bicycle lamp of claim 1, wherein said light sensor unit is a photoresistor.
